(19) United States
(12) Patent Application Publication
(10) Pub. No.: US 2014/0366445 A1
(43) Pub. Date: Dec. 18, 2014

(54) Seed incubator

(71) Applicant: John Adam Jakimas, Kearny, NJ (US)

(72) Inventor: John Adam Jakimas, Kearny, NJ (US)

(21) Appl. No.: 13/986,876

(22) Filed: Jun. 14, 2013

(51) Int. Cl. A01C 1/02

(52) U.S. Cl. CPC A01C 1/02
USPC 47/79

(57) ABSTRACT

My invention, the “Seed Incubator” is a new and unique way of propagating seeds without the use of electricity or mechanical components. Gravity is used to create a micro climate within the growing chamber with the adjustment of air flow located at the top and mid section of the chamber. This air flow adjustment capability allows seeds and plants the right amount of water they need to develop and grow specifically to their requirements. Simply stated: Less air flow, less water to the seed. More air flow, more water to the seed.

### CROSS-REFERENCE TO RELATED APPLICATIONS

“Not Applicable”

### STATEMENT REGARDING FEDERALLY SPONSTERED RESEARCH OR DEVELOPMENT

“Not Applicable”

### REFERENCE TO SEQUENCE LISTING

“Not Applicable”

### BACKGROUND OF INVENTION

My invention, “Seed Incubator” pertains to horticulture and specifically the germination of seeds.

### BRIEF SUMMARY OF THE INVENTION

The “Seed Incubator” is an easy to use invention that helps with seed germination. It can be used by the private individual or commercial business. The “Seed Incubator” works by allowing the creation and utilization of a multitude of micro-climates within the unit invention. Many seeds have specific requirements for proper germanation and this invention makes meeting those requirements possible. It can save the home gardener as well as commercial grower time and expense by germanating every living seed. The “Seed Incubator” gives seeds the proper micro climate to start and succeed in its full life cycle.

### BRIEF DESCRIPTION OF THE SEVERAL VIEWS OF THE DRAWING

(Detailed on separate sheet)

### DETAILED DESCRIPTION OF THE INVENTION

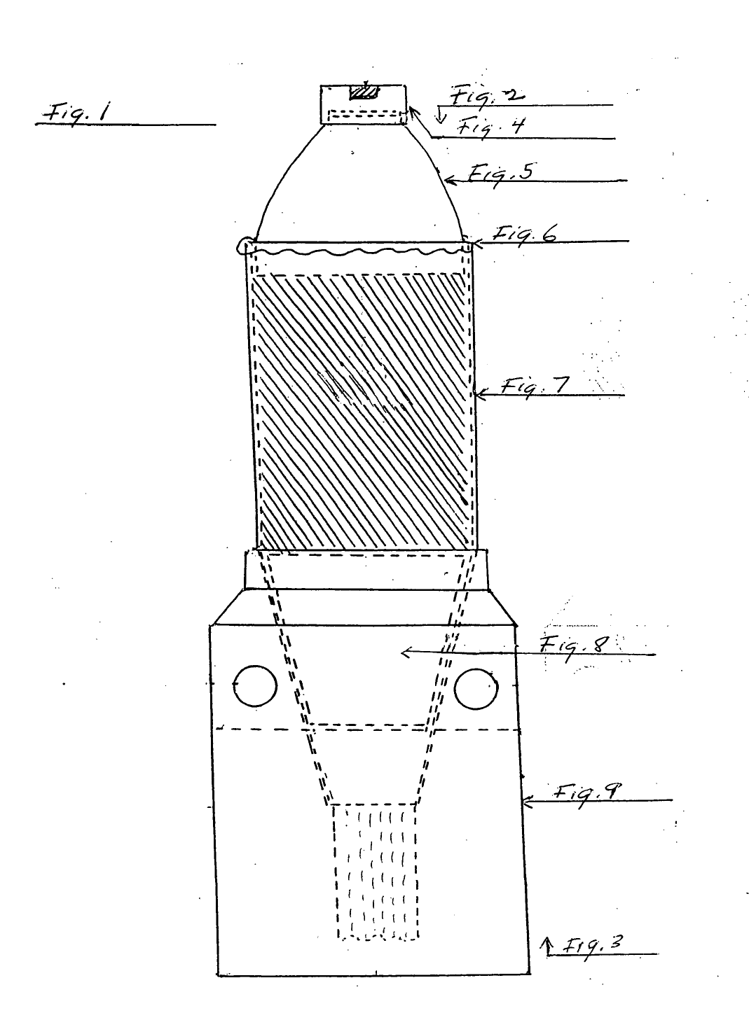

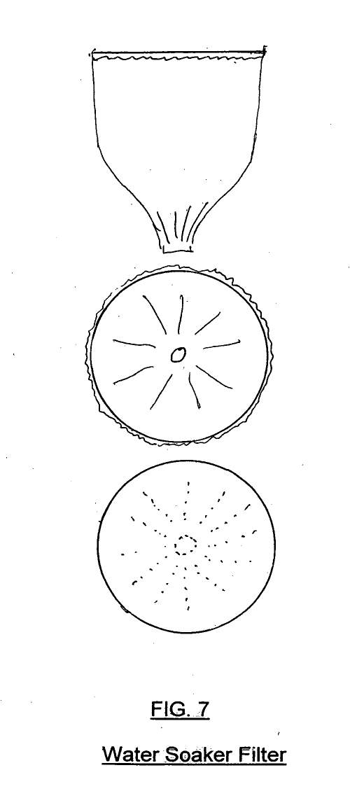

The “Seed Incubator”, FIG. 1, total view, create unique micro climates necessary to germanate various seeds. Micro climates are achieved by the “Seed necessary to germanate various seeds. Micro climates are achieved by the “Seed Incubator” by adjusting air flow that regulates water saturation to the soil. The “Seed Incubator” is made primarily of clear plastic except for the Water Soaker Filter, FIG. 7, which is made of paper fiber.

A detailed description of the “Seed Incubator” is as follows:

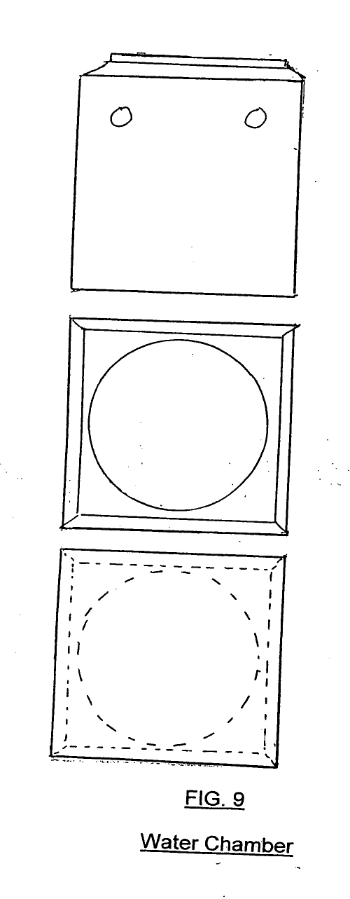

First, water is filled in the Water Chamber, FIG. 9, just below the 2 permanent air intake holes marked as “water level” on Drawing sheet 1 of 9.

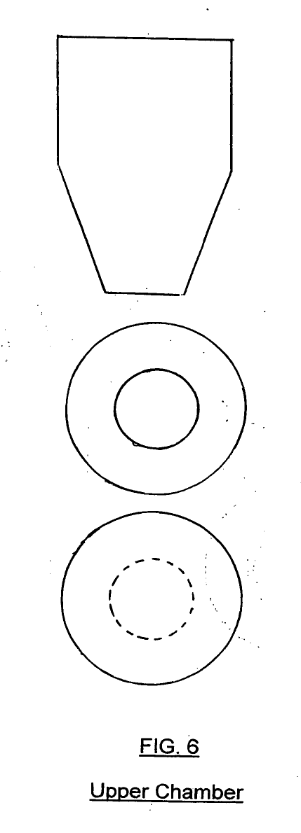

Second, A thin, pre-formed, cone shaped, Water Soaker Filter, FIG. 7, is placed inside the Upper Chamber, FIG. 6 sitting flat against the walls of the interior Upper Chamber, FIG. 6 and then protruding down through the Upper Chamber, FIG. 6 to the top opening of Soil Support Cone to absorb water from the Water Chamber, FIG. 9.

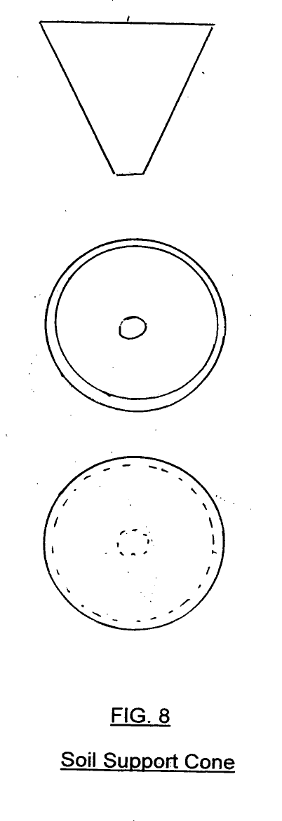

Third, a Soil Support Cone, FIG. 8, is placed and seated at the bottom of the Upper Chamber, FIG. 6 which prevents soil from falling into the Water Chamber, FIG. 9.

Fourth, soil and seed are added to the top of the Soil Support Cone, FIG. 8, to the soil height desired making contact with the walls of the Water Soaker Filter, FIG. 7.

Fifth, the Upper Chamber, FIG. 6 now containing the Water Soaker Filter, FIG. 7, Soil Support Cone, FIG. 8, soil and seed, is now ready to be placed down and seated into the Water Chamber, FIG. 9, opening and into its final position.

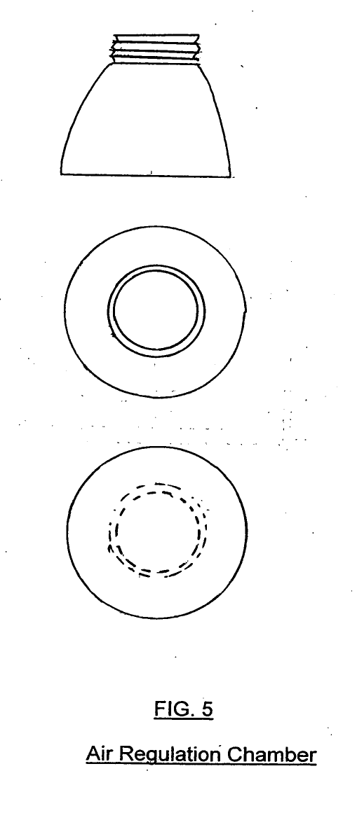

Sixth, the Air Regulation Chamber, FIG. 5, is placed on top of the Upper Chamber, FIG. 6, sitting at soil height. The Air Regulation Chamber, FIG. 5, is loose fitting and can be positioned up or down to any soil level within the Upper Chamber, FIG. 6.

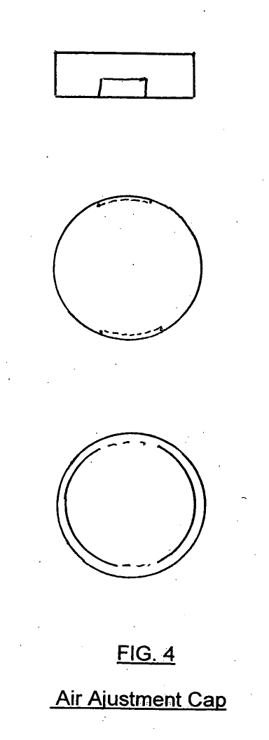

Seventh and last, the Air Adjustment Cap, FIG. 4, is secured on to the Air Regulation Chamber, FIG. 5, by screwing it on to the top of the Air. Regulation Chamber, FIG. 5. The Air Adjustment Cap, FIG. 4, contains a 2 small ventilation holes for proper air requirements that also adjusts water saturation levels for any seed giving it all the specific elements it needs to grow. END.

### BRIEF DESCRIPTION OF DRAWINGS

Sheet 1 of 9, FIG. 1.

This drawing represents the frontal or side View of the complete “Seed Incubator” unit. All side views are the same with the exception of the front view which shows 2 air opening holes. The three remaining sides of the “Seed Incubator” do not have air holes.

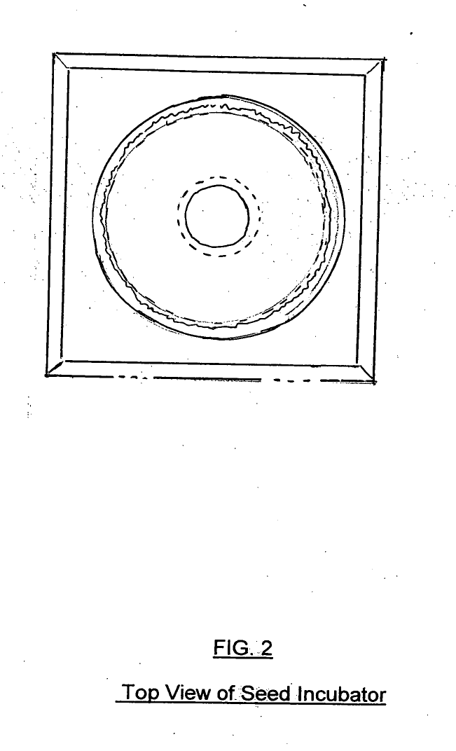

Sheet 2 of 9, FIG. 2

This drawing is the top view of the complete “Seed Incubator” looking down on it.

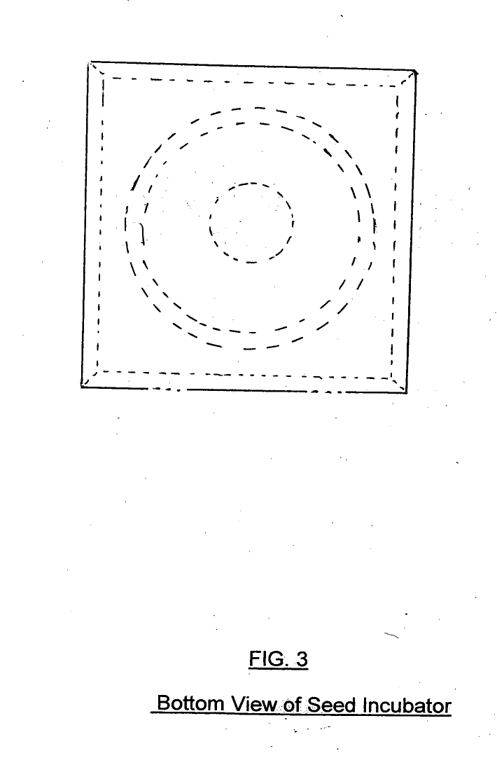

Sheet 3 of 9, FIG. 3

This drawing is the bottom view of the complete “Seed Incubator” turned upside down.

Sheet 4 of 9, FIG. 4.

This drawing is three views of the “Air Adjustment Cap”. Top, bottom and side view. This componet regulates air flow into the unit and allows water saturation to be adusted.

Sheet 5 of 9, FIG. 5

This drawing is three views of the “Air Regulation Chamber”. Top, bottom and side view. This is a loose fitting componet that maintains the air within the unit and can be pushed up or down to adjust to the soil height.

Sheet 6 of 9, FIG. 6.

This drawing is three views of the “Upper Chamber”. Top, bottom and side view. This componet holds all top components together by providing a chamber for them.

Sheet 7 of 9, FIG. 7.

This drawing is three views of the “Water Soaker Filter”. Top, bottom and side view. This componet draws up water into the soil by means of a water soluable paper fabric filter.

Sheet 8 of 9, FIG. 8.

This drawing is three views of the “Soil Support Cone”. Top bottom and side view. This componet holds the soil and “Water Soaker filter” in place for the seed.

Sheet 9 of 9, FIG. 9.

This drawing is three views of the “Water Chamber”. Top, bottom and side view. This componet holds water in place acting as a water storage vessel for the unit.

1. The Seed Incubator incorporates unique micro climate capabilities for seed germination. The flexability of this micro climate feature by air adjustment flow regulating moisture to the soil from the Water Soaker Filter works with seven “Component Parts for the System” or claims.
1) Multi—flow Moisturizing Air Cap—(Removed when not in use)
2 & 3) Plastic Cone—Sets on and into Plastic Jar which contains water and make up air.
4 & 5) Paper Cone Soaker is put in the plastic cone and into the jar of water and air.
6) Soil is now added to fill the paper cone.
7) Warm water added to 1 inch below air holes of the jar. Now the system begins.
